(19) United States
(12) Patent Application Publication
(10) Pub. No.: US 2025/0119622 A1
(43) Pub. Date: Apr. 10, 2025

(54) Methods and Systems for Providing Alternative Audio Content

(71) Applicant: Comcast Cable Communications, LLC, Philadelphia, PA (US)

(72) Inventors: Brandon Burnette, Philadelphia, PA (US); Julianne Heinzmann, Philadelphia, PA (US); Arun Ravisankar, Philadelphia, PA (US)

(21) Appl. No.: 18/481,159

(22) Filed: Oct. 4, 2023

(51) Int. Cl. H04N 21/488; G10L 15/00; G10L 15/26; H04N 21/431; H04N 21/81

(52) U.S. Cl. CPC H04N 21/4884; G10L 15/005; G10L 15/26; H04N 21/4316; H04N 21/8106

(57) ABSTRACT

Systems, apparatuses, and methods are described for receiving content and closed captioning text based on audio in the content. Alternative closed captioning text and/or alternative audio may be generated based on a translation of the content. Voice characteristics of recognized speech may be used in the generation of alternative closed captioning text and/or alternative audio. Further, the alternative closed captioning text and/or alternative audio may be outputted in place of the original closed captioning text and/or audio.

### BACKGROUND

Closed captioning text may be used to enhance the viewing experience for a variety of viewers including those who experience difficulty understanding an audio track as well as viewers that wish to view text in a preferred language when an audio track in another language is being outputted. In some cases, closed captioning text may not accurately reflect the dialog of an audio track due to, for example, closed captioning text may be marred by transcription errors and/or translation errors. Further, differences in the times at which closed captioning data and audio-video data are received may result in inconsistencies that significantly reduce the usefulness of the closed captioning text. Additionally, closed captioning text and/or audio tracks for some languages may not be available for certain content, which may frustrate viewers who wish to hear audio in their native language or have closed captioning text in their native language.

### SUMMARY

The following summary presents a simplified summary of certain features. The summary is not an extensive overview and is not intended to identify key or critical elements.

Systems, apparatuses, and methods are described for generating alternative closed captioning text and/or alternative audio based on content received by a device (e.g., content received by an edge device in a content delivery network). For example, content (e.g., audio and/or video content) may be received by an edge device that may be used by a user of the edge device to consume (e.g., view and/or listen to) the content. Speech in the original audio of content analyzed (e.g., by outputting a small portion, fingerprint data matching, or any other data analysis technique) by an application of an edge device may be recognized and used as the basis for accessing or generating alternative audio content, or closed captioning text, that comprises text that is translated into a language that is different from the language of the original audio and/or original closed captioning text that was received. Further, an edge device may access or generate alternative audio that is translated into a different language from the language of the original audio and/or original closed captioning text. The edge device may automatically generate (or access an available) alternative closed captioning text and/or alternative audio based on the recognition of a language being spoken around the edge device. For example, a Russian speaking user may cause an edge device to generate Russian language closed captioning text for French language content that is being consumed by the user. Additionally, an edge device may recognize different voices in content and use the voice characteristics of the different voices to generate alternative audio. For example, an edge device may receive content with an adult father and a ten year old son speaking in French. The edge device may then generate alternative audio in which the father's dialog is spoken in Russian with an adult man's voice and the son's dialog is spoken in Russian with the voice of a ten year old boy. The disclosed technology may provide more effective, convenient, and accessibility friendly generation of alternative closed captioning text and/or alternative audio in a preferred language. Further, the disclosed technology may allow for an improvement in the accuracy of translated closed captioning text and/or translated audio by leveraging the use of machine learning models that are configured to transcribe and translate text and/or audio.

These and other features and advantages are described in greater detail below.

### BRIEF DESCRIPTION OF THE DRAWINGS

Some features are shown by way of example, and not by limitation, in the accompanying

drawings. In the drawings, like numerals reference similar elements.

FIG. 1 shows an example communication network.

FIG. 2 shows hardware elements of a computing device.

FIG. 3 shows an example data flow for generating caption data of audio locally at an edge device.

FIGS. 4A-B show examples of generating alternative closed captioning text.

FIGS. 5A-B show examples of generating alternative audio.

FIGS. 6A-B show examples of generating alternative voices.

FIG. 7 is a flow chart showing an example method for generating alternative closed captioning text based on recognition of speech in content.

FIG. 8 is a flow chart showing an example method for generating alternative audio based on recognition of speech in content.

FIG. 9 is a flow chart showing an example method for generating alternative audio comprising different voices based on recognition of speech in content.

### DETAILED DESCRIPTION

The accompanying drawings show examples of the disclosure. It is to be understood that the examples shown in the drawings and/or discussed herein are non-exclusive and that there are other examples of how the disclosure may be practiced.

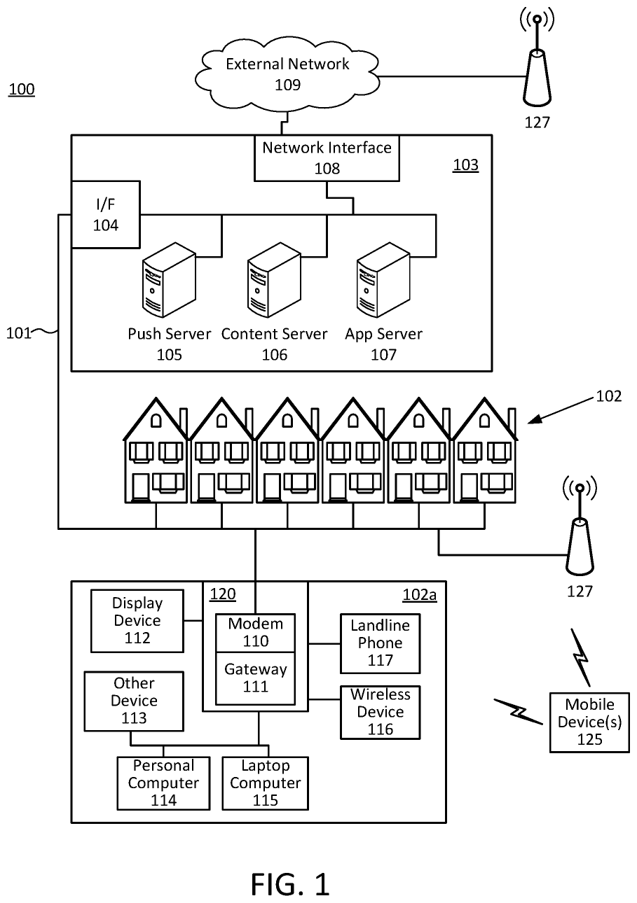

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a Wi-Fi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as additional push, content, and/or application servers, and/or other types of servers. Although shown separately, the push server 105, the content server 106, the application server 107, and/or other server(s) may be combined. The servers 105, 106, 107, and/or other servers, may be computing devices and may comprise memory storing data and also storing computer executable instructions that, when executed by one or more processors, cause the server(s) to perform steps described herein.

An example of the premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA)), landline phones 117 (e.g., Voice over Internet Protocol—VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on-or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

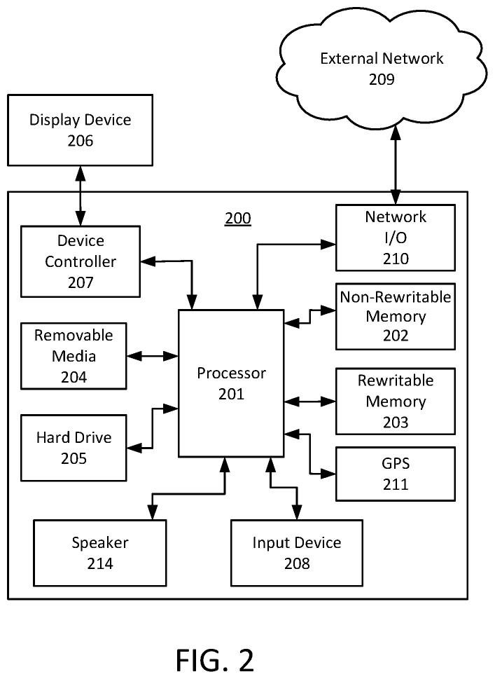

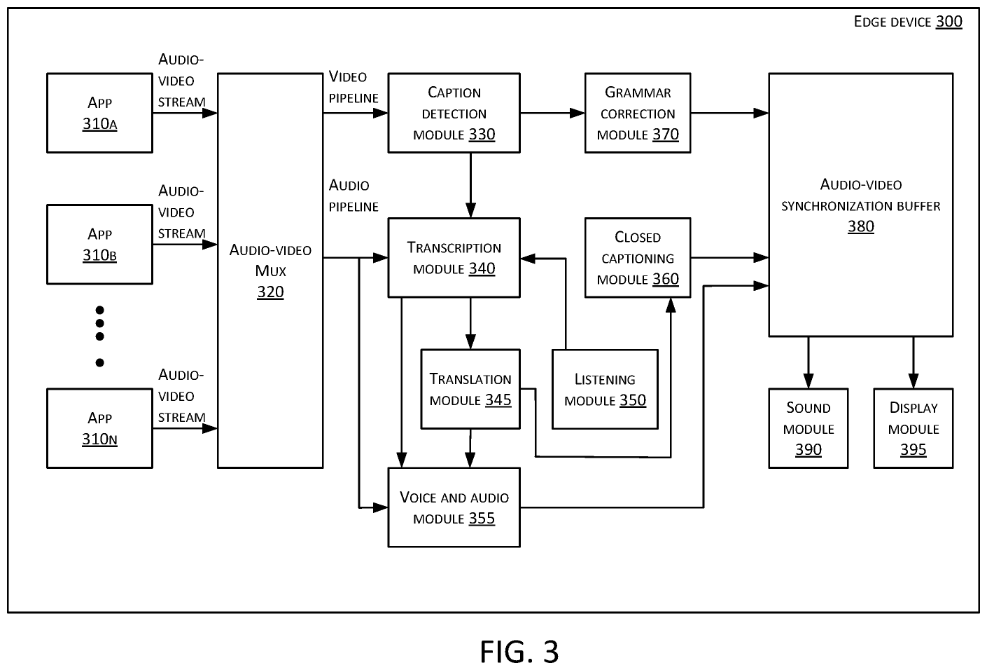

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices discussed herein (e.g., an edge device 300 as shown in FIG. 3). The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media.

The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

FIG. 3 shows an example data flow for generating caption data of audio locally at the edge device 300. The edge device may comprise a computing device that is configured to receive content (e.g., content comprising video, audio, and/or closed captioning text) from a content source based on a request to the content source from the edge device. For example, the edge device 300 may comprise a display device (e.g., a smartphone or smart television) that streams video content based on a request to a video content source (e.g., content server 106) that stores the video content and sends the video content to the edge device.

The edge device 300 may generate caption data based on audio of content being played on the edge device 300, and may overlay the generated caption data on video of the content. Closed captioning text (e.g., original closed captioning text) may comprise text (e.g., a combination of words, numbers, and/or other symbols) that may be outputted with video of the content and may be synchronized with audio of the content that is being outputted at the same time the closed captioning text is being outputted. For example, closed captioning text may comprise dialogue for a show that is displayed at the same time that the corresponding audio for the show is outputted. Further, the closed captioning text may comprise a translation of the audio of content that may allow content viewers that do not understand the language of the audio of content to understand what is being said in the audio of the content.

Under some circumstances, the closed captioning text may not be consistent with the audio (e.g., the closed captioning text may be improperly synchronized with the audio). The inconsistency between closed captioning text and audio may, for example, result from a difference between the time the audio and closed captioning text are received by the edge device 300, data of the closed captioning text being corrupted during transmission from a content source, and/or the closed captioning text having been improperly synchronized when it was originally generated. The edge device 300 may mitigate issues by generating alternative closed captioning text and/or alternative audio (e.g., audio in a different language from the audio of content) on the edge device 300 by using audio that is being output, as such locally generated captioning may be more accurately synchronized. If the video of the content comprises closed captioning text, the edge device 300 may use the locally generated caption data associated with the audio instead of and/or together with the closed captioning comprised in the video.

The edge device 300 may comprise at least one of the display devices 112 (e.g., smart televisions), the other devices 113 (e.g., a STB), the personal computers 114, the laptop computers 115, the wireless devices 116 (e.g., wireless laptops, notebooks), the mobile devices 125 (e.g., smart phones, tablets), and/or any other desired devices. The edge device 300 may comprise one or more applications 310a-310n, an audio-video multiplexer (mux) 320, a caption detection module 330, a transcription module 340, a translation module 345, a listening module 350, a voice and audio module 355, a closed caption module 360, a grammar correction module 370, an audio-video synchronization buffer 380, a sound module 390, and/or a display module 395. The modules and other elements of edge device 300 need not be separate and may comprise one or more functions performed by one or more processors 201 of the edge device 300, following the execution of instructions such as a computer program stored by the edge device 300.

The one or more applications 310a-310n, running on the edge device 300, may play content. The one or more applications 310a-310n may, for example, comprise streaming video applications, streaming audio applications, and/or other applications that may receive and/or generate content that may be outputted via edge device 300. The audio-video mux 320 may receive (e.g., from the one or more applications 310a-310n) audio and/or video (e.g., one or more audio-video streams) and select a particular audio-video stream for consumption by a user (e.g., a user that is a viewer of content outputted by the edge device 300). The applications 310a-310n may provide their own closed captioning. Different applications 310a-310n may use different language models to generate closed captioning text. The closed captioning text of different applications 310a-310n may be encoded in different languages and/or formatted differently. The caption detection module 330 may receive the video stream (e.g., selected by the audio-video mux 320). The caption detection module 330 may be configured to determine whether to generate caption data for the audio stream based on the video stream. The caption detection module 330 may indicate whether the video stream comprises captions, whether the captions are in a target language (e.g., the user's language), and/or whether the caption text is appropriately formatted (e.g., font, size, style, color, etc.).

The transcription module 340 may receive the audio stream (e.g., selected by the audio-video mux 320) and generate caption data that may comprise a transcription of the audio stream based on the indication from the caption detection module 330. The transcription module 340 may generate caption data for the audio stream if the video stream lacks captions, the captions use a language other than the user's language, the format of the caption text is inappropriate, and/or in any other case.

The transcription module 340 may be configured and/or trained to generate a transcription of content (e.g., audio content) based on the audio portion of the audio-video mux 320. Further, the transcription module 340 may be configured to detect and/or recognize speech in an audio stream (e.g., whether a portion of audio includes speech and/or non-speech sounds), analyze recognized speech in audio, generate a transcription of speech that is recognized (e.g., generate a transcription of speech in audio content based on use of one or more machine learning models comprising a speech recognition model that is configured to detect and/or recognize speech in content comprising audio), identify different voices (e.g., different voices corresponding to different speakers) recognized in audio, determine voice characteristics of voices recognized in speech (e.g., determine gender, age, pitch, and/or accent characteristics of a voice), and/or determine a type of speech (e.g., speaking in a normal tone, shouting, whispering, and/or singing).

The transcription module 340 may comprise one or more machine learning models which may comprise parameters that have adjustable weights and/or fixed biases. As part of the process of training the transcription module 340, values associated with each of the weights of the transcription module 340 may be modified based on the extent to which each of the parameters contributes to increasing or decreasing the accuracy of output generated by the transcription module 340. For example, parameters of the transcription module 340 may correspond to various aural features of audio. Over a plurality of iterations, and based on inputting training data (e.g., training data comprising features including audio content and/or features similar to features of the audio-video mux 320) to the transcription module 340, the weighting of each of the parameters may be adjusted based on the extent to which each of the parameters contributes to accurately recognizing speech, generating a transcription of recognized speech, identifying different voices, determining voice characteristics of voices, and/or determining a type of speech.

Training the transcription module 340 may comprise the use of a cost function that is used to minimize the error between output of the transcription module 340 and a ground-truth value. For example, the transcription module 340 may receive input comprising training data similar to the audio-video mux 320. Further, the training data may comprise features of portions of content comprising audio-video content (e.g., portions of audio-video shows) and/or portions of audio content (e.g., portions of purely audio shows). Further, the training data may comprise ground truth information that indicates whether a portion of training data includes speech, a transcription of speech in training data, an indication of the identities of different voices in training data, voice characteristics of voices in training data, and/or a type of speech in training data.

Accurate output by the transcription module 340 may include accurately recognizing speech in audio (e.g., recognizing speech when speech is present in a portion of audio and not recognizing speech when there is no speech in a portion of audio), accurately transcribing dialog in a portion of audio, accurately identifying different voices, accurately identifying voice characteristics in a portion of audio, and/or accurately identifying a type of speech in a portion of audio. Over a plurality of training iterations, the weighting of the parameters of the transcription module 340 may adjusted until the accuracy of the machine learning model's output reaches some threshold accuracy level (e.g., 98% accuracy).

A translation module 345 may be configured to translate the transcription. The translation module 345 may be configured to translate a transcription (e.g., a transcription generated by transcription module 340) into one or more languages using one or more language models corresponding to the one or more languages and/or the language of the transcription.

The translation module 345 may translate the transcription (e.g., using a translation model) based on a user profile. The translation module 345 may comprise translation rules, for example, for parental control to provide different translations depending on the age of the user. The translation module 345 may be configured to download a language model, for example, from a server (e.g., the application server 107) if the edge device 300 lacks the language model which is required to translate the transcription into a particular language. The translation module 345 may be configured to prompt the user to select the one or more particular languages in which the user wants to translate the transcription. The translation module 345 may be configured and/or trained to generate a translation of audio (e.g., the audio portion of the audio-video mux 320) from one language into a different language. Further, the translation module 345 may determine a language that is being spoken in an audio stream (e.g., whether a portion of audio includes speech in a particular language). For example, the translation module 345 may determine that the English language is being spoken in a portion of audio. The translation module 345 may generate alternative closed captioning text and/or alternative audio (e.g., synthetic voices that speak dialog indicated in a transcript) based on content comprising original closed captioning text (e.g., a transcript of audio generated by the transcription module 340) and/or original audio. For example, the translation module 345 may generate alternative closed captioning text in Russian based on English language audio and/or English language closed captioning. Further, the translation module 345 may generate Russian language audio based on English language audio and/or English language closed captioning text. Additionally, the translation module 345 may translate audio that comprises different languages. For example, the translation module 345 generate Russian language closed captioning text and/or Russian language audio based on content comprising audio in which a combination of the Indonesian language and the French language are spoken.

The translation module 345 may, for example, comprise one or more machine learning models which may comprise parameters that have adjustable weights and/or fixed biases. As part of the process of training the translation module 345, values associated with each of the weights of the translation module 345 may be modified based on the extent to which each of the parameters contributes to increasing or decreasing the accuracy of output generated by the translation module 345. For example, parameters of the translation module 345 may correspond to various aural features of different languages. Over a plurality of iterations, and based on inputting training data (e.g., training data comprising features including audio content and/or features similar to features of the audio-video mux 320) to the translation module 345, the weighting of each of the parameters may be adjusted based on the extent to which each of the parameters contributes to accurately recognizing a particular language and translating the recognized language into a different language.

Training the translation module 345 may comprise the use of a cost function that is used to minimize the error between output of the translation module 345 and a ground-truth value (e.g., a ground-truth translated transcription). For example, the translation module 345 may receive input comprising training data similar to the audio-video mux 320 in a variety of different languages. Further, the training data may comprise features of portions of content comprising closed captioning text in various languages and/or portions of audio content in various languages. Further, the training data may comprise ground truth information that indicates the language of a portion of closed captioning text and/or audio as well as a transcript of the closed captioning text and/or audio. Accurate output by the translation module 345 may include accurately determining the language of closed captioning text and/or audio and/or accurately generating a translated transcription and/or alternative audio (e.g., audio in a different language from the recognized language) based on closed captioning text and/or audio. Minimization of error may comprise reducing differences between a translated transcription generated by translation module 345 and the ground-truth translated transcription. Over a plurality of training iterations, the weighting of the parameters of the translation module 345 may adjusted until the accuracy of the machine learning model's output reaches some threshold accuracy level (e.g., 99% accuracy).

The voice and audio module 355 may receive the audio stream (e.g., selected by the audio-video mux 320). The voice and audio module 355 may be configured to generate alternative audio based on the audio in the audio stream. For example, the edge device 300 may be configured to generate alternative audio (e.g., Russian language audio) based on recognized French language speech extracted from the audio-video mux 320. Further, the voice and audio module 355 may be configured to pass the audio in the audio stream to the audio-video synchronization buffer 380 without generating alternative audio or changing the audio. For example, an English speaking user of the edge device 300 who doesn't speak Japanese may prefer to view closed-captioning text in English while listening to the original Japanese language audio of animated content. To preserve the original Japanese audio, the edge device 300 may be configured to pass the Japanese audio from the voice and audio module 355 to the audio-video synchronization buffer 380 without altering the audio or generating alternative audio in the English language. The voice and audio module 355 may generate alternative if the audio stream is missing, silent, or lacks audible speech (e.g., the voice and audio module 355 may generate synthetic voices that produce speech based on the transcription generated by transcription module 340) and/or the audio comprises speech that is in a language other than a preferred language (e.g., a preferred language selected by a viewer of content outputted by the edge device 300).

Additionally, the voice and audio module 355 may identify different voices (e.g., different voices corresponding to different speakers) recognized in audio content, determine voice characteristics of voices recognized in speech (e.g., determine gender, age, and/or accent characteristics of a voice) used in audio content, and/or determine a type of speech (e.g., speaking in a normal tone, shouting, whispering, and/or singing) recognized in audio content. The voice and audio module 355 may then generate audio based on the voice characteristics of speech recognized in content. For example, the voice and audio module 355 may detect two voices (e.g., an adult female voice and a male child's voice) that use the English language in audio content. The voice and audio module 355 may then determine voice characteristics of the audio content and generate voice profiles for the two voices that were recognized. When the voice and audio module 355 generates alternative audio in a different language (e.g., Russian) from the language in the original audio content, the voice profiles generated for the two voices may be applied to the synthetic speech that is generated such that the voices in the alternative audio are similar to the voices of the original audio.

The voice and audio module 355 may comprise one or more machine learning models that are configured and/or trained to generate alternative audio based on audio (e.g., audio from the audio portion of the audio-video mux 320) and/or a transcription of content (e.g., the transcription of content generated by transcription module 340).

The voice and audio module 355 may comprise one or more machine learning models which may comprise parameters that have adjustable weights and/or fixed biases. As part of the process of training the voice and audio module 355, values associated with each of the weights of the voice and audio module 355 may be modified based on the extent to which each of the parameters contributes to increasing or decreasing the accuracy of output generated by the voice and audio module 355. For example, parameters of the voice and audio module 355 may correspond to various aural features of audio. Over a plurality of iterations, and based on inputting training data (e.g., training data comprising features including audio content and/or features similar to features of the audio-video mux 320) to the voice and audio module 355, the weighting of each of the parameters may be adjusted based on the extent to which each of the parameters contributes to accurately recognizing speech, generating a transcription of recognized speech, identifying different voices, determining voice characteristics of voices, and/or determining a type of speech.

Training the voice and audio module 355 may comprise the use of a cost function that is used to minimize the error between output of the voice and audio module 355 and a ground-truth value. For example, the voice and audio module 355 may receive input comprising training data similar to the audio-video mux 320. Further, the training data may comprise features of portions of audio content (e.g., portions of audio shows). Further, the training data may comprise ground truth information that indicates whether a portion of training data includes speech, a transcription of the speech included in the training data, an indication of the identities of different voices in the training data, voice characteristics of voices in the training data, and/or a type of speech in the training data.

Accurate output by the voice and audio module 355 may include accurately recognizing speech in audio (e.g., recognizing speech when speech is present in a portion of audio and not recognizing speech when there is no speech in a portion of audio), accurately transcribing dialog in a portion of audio, accurately identifying different voices, accurately identifying voice characteristics in a portion of audio, and/or accurately identifying a type of speech in a portion of audio. Over a plurality of training iterations, the weighting of the parameters of the voice and audio module 355 may adjusted until the accuracy of the machine learning model's output reaches some threshold accuracy level (e.g., 98% accuracy).

The transcription module 340, the translation module 345, and/or the voice and audio module 355 may, for example, comprise one or more machine learning models any of which may operate singularly or in combination to perform the operations described herein. For example, the transcription module 340, the translation module 345, and/or the voice and audio module 355 may comprise one or more neural networks (e.g., convolutional neural networks (CNNs)), one or more support vector machines (SVMs), and/or one or more Bayesian hierarchical model. Further, the transcription module 340, the translation module 345, and/or the voice and audio module 355 may be trained using various training techniques including supervised learning, unsupervised learning, semi-supervised learning, and/or reinforcement learning. The transcription module 340 may be configured to perform the operations of the translation module 345 and/or generate output generated by the translation module 345. For example, the transcription module 340 may be configured and/or trained to generate a translation of a transcription generated by transcription module 340. Further, the translation module 345 may be configured to perform the operations of the transcription module 340 and/or generate output generated by the transcription module 340. For example, the translation module 345 may be configured and/or trained to generate a transcription of audio content, then generate a translation of the transcription.

The transcription module 340, the translation module 345, and/or the voice and audio module 355 may be configured to centrally store data (e.g., a transcription of content and/or a translation of content) in a server (e.g., the content server 106) for reuse not only by the edge device 300, but also by other devices playing the same content. For example, the transcription module 340 may use the transcription of content stored in a central server, instead of generating the transcription for the same content. Further, the translation module 345 may use the translation of the content stored in a central server, instead of generating the translation for the same content.

The listening module 350 (e.g., a microphone) may be configured to record speech from the one or more users. The listening module 350 may be comprised in the edge device 300 as shown in FIG. 3 and/or comprised in other devices (e.g., proximate to the user), such as a remote control, a handheld device, etc. The listening module 350 may be configured to recognize speech that is spoken in proximity (e.g., within a distance that the listening module 350 is able to recognize speech) to the edge device 300. Listening module 350 may comprise a plurality of microphones that may be used to triangulate the location of a source of a sound. For example, the listening module 350 may be configured to determine that the sound of speech is being produced at a location three meters away from the listening module 350 and that the sound of music playing is being produced at a location twenty meters away. Further, the listening module 350 may be configured to detect, recognize, and/or record sounds (e.g., speech from one or more users) that are within a predetermined distance of the listening module 350. For example, the listening module 350 may be configured to record speech within a five meter radius of the listening module 350 and not to record speech that is outside the five meter radius. The speech recorded within the predetermined distance (e.g., the five meter radius) may be processed and used by another module such as translation module 345, which may translate the recorded speech. Further, the listening module 350 may be configured to recognize the speech of a viewer of content as the content is being outputted on the edge device 300. The speech of the viewer of the content may be sent to the translation module 345 which may determine the language of the speech.

The language of the speech recognized by listening module 350 may then be used to determine whether the language of content matches the recognized speech. Based on the language of the recognized speech not matching the language of the content, translation module 345 may translate the language of the content into the language of the recognized speech. For example, if listening module 350 detects speech and sends an audio sample of the speech to translation module 345, then translation module 345 may determine that the language being spoken in the audio sample is the Russian language. Based on information in the audio of content being outputted and/or closed captioning text, the translation module 345 may determine that the language of the content is English. Based on the Russian language being recognized by listening module 350 and the audio of content being spoken in the English language, the translation module 345 may generate Russian language closed captioning text and/or Russian language audio based on the closed captioning text and/or audio of the content being outputted.

The closed caption module 360 may generate caption data based on the transcription and/or the translation and overlay the caption data on the video stream. The caption data may comprise the transcription and/or the translations in one or more different languages. The closed caption module 360 may be configured to determine an on-screen location of the caption data for the overlay. If the video stream comprises existing captions (e.g., provided by the applications 310a-310n), the closed caption module 360 may determine the location of the caption data in the particular language (e.g., determined using the listening module 350) based on an onscreen location of the existing captions. The closed caption module 360 may overlay the caption data in the same location as the existing captions, for example, to overwrite the existing captions with the caption data. The closed caption module 360 may be configured to determine the location of the caption data for the overlay based on one or more languages (e.g., selected using the audio recording via the listening module 350). For example, the closed caption module 360 may overlay the caption data adjacent to the existing captions, if the one or more selected languages comprises the language of the existing captions. The closed caption module 360 may be configured to determine the format (e.g., font, size, style, color, etc.) of the caption data for the overlay. The closed caption module 360 may determine the format of the caption data based on the format of the existing captions. For example, the closed caption module 360 may set the format of the caption data to match the format of the existing captions.

The grammar correction module 370 may be configured to receive the video stream comprising the existing captions and to process a grammar check of the existing captions. The grammar correction module 370 may correct grammar errors in the existing captions, if the grammar correction module 370 detects the grammar errors in the existing captions. The grammar correction module 370 may replace the errors in the existing captions with the corrections (e.g., corrected words and/or phrases). The grammar correction module 370 may indicate the corrected words and/or phrases, for example, by highlighting, such as underlining, parentheses, coloring, and/or any other highlighting.

The audio-video synchronization buffer 380 may receive the audio stream and the video stream comprising the caption data (e.g., generated by the closed caption module 360) and/or the video stream comprising the existing captions (e.g., corrected by the grammar correction module 370). The audio-video synchronization buffer 380 may be configured to select one of the video streams to display either the generated caption data or the corrected existing captions, and/or to combine the video streams to display both of the generated caption data and the corrected existing captions. The audio-video synchronization buffer 380 may be configured to synchronize the audio stream with the selected video stream and/or the combined video stream. The sound module 390 and/or the display module 395 may output the synchronized audio and/or video stream, respectively. The sound module 390 may output alternative audio via audio output devices (e.g., loud speakers) of the edge device 300. The display module 395 may output alternative content comprising an overlay (e.g., an overlay comprising alternative closed captioning text in a language that is different from the originally received closed captioning text and/or original audio) via a display output device (e.g., a smartphone display device or display device of a laptop computing device) of the edge device 300.

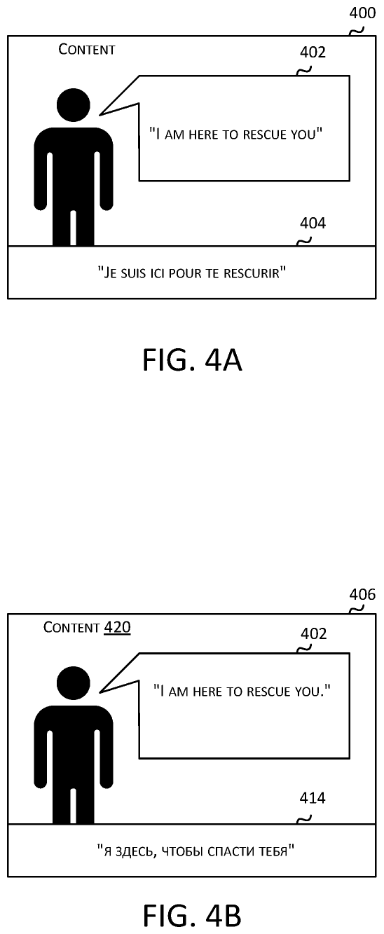

FIGS. 4A-B show examples of generating alternative closed captioning text. The computing devices shown in FIGS. 1-2 (e.g., the one or more mobile devices 125 and/or the edge device 300) and/or any other computing devices described herein may be used to implement the operations described herein.

In FIG. 4A, content 400 is outputted to a display device. The content 400 comprises the recognized speech 402, which is based on audio of the content 400 that indicates “I AM HERE TO RESCUE YOU.” The recognized speech 402 may, for example, be recognized using the speech recognition techniques described herein such as the transcription module 340 that is described with respect to FIG. 3. The transcription module 340 may then send data comprising the recognized speech to the translation module 345 which may determine that the recognized speech 402 is in the English language.

The computing device outputting the content 400 may be configured to translate the language of the recognized speech into another language. For example, the determination of the target language into which to translate the recognized speech 402 may be based on user selection (e.g., a viewer of the content may interact with an interface and select an option to translate speech and generate alternative closed captioning text in a preferred language based on the originally received content) or automatically by using a listening module 350 (e.g., a listening module configured to process audio detected by microphones of the display device) to recognize a language being spoken by viewers of the content in the vicinity of the display device. If the recognized speech 402 does not match the language being spoken by the viewers, the translation module 345 may translate the recognized speech into the same language being spoken by the viewers and then generate alternative closed captioning text in the language being spoken by the viewers.

The translated language generated by the translation module 345 may then be outputted in the form of alternative closed captioning text 404. The alternative closed captioning text 404 may comprise an overlay that is superimposed over a portion of the content at the bottom of the content 400. The alternative closed captioning text 404 may replace original closed captioning text (e.g., English language closed captioning text) that is shown in the portion of the content 400 in which the alternative closed captioning text 404 is generated. In this example, the alternative closed captioning text 404 is a French language translation of the English language closed captioning text indicating “I AM HERE TO RESCUE YOU” and indicates “JE SUIS IC POUR TE RESCURIR” in the French language.

In FIG. 4B, the content 406 which may be similar to the content shown in FIG. 4A is outputted to a display device. In this example, the computing device outputting the content 406 may have been configured to translate the recognized speech 402 from English into Russian. The alternative closed captioning text 414 generated on the display device indicates “ [symbol] , [symbol] [symbol] [symbol] ” which uses a Cyrillic character set and not the Latin character set used to translate the recognized speech 402 from English into French as described with respect to FIG. 4A. The computing device may be configured to generate alternative closed captioning text using a variety of character sets comprising, for example, Latin, Cyrillic, Greek, Chinese, Thai, Devanagari, and/or Arabic.

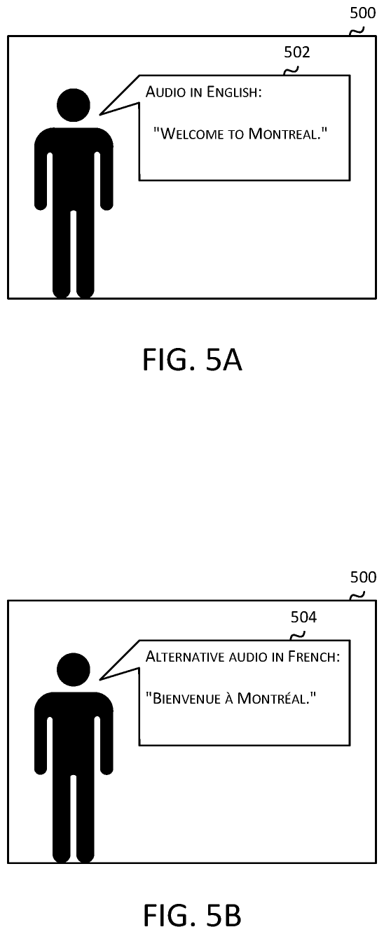

FIGS. 5A-B show examples of generating alternative audio. The computing devices shown in FIGS. 1-2 (e.g., the one or more mobile devices 125 and/or the edge device 300) and/or any other computing devices described herein may be used to implement the operations described herein.

In FIG. 5A, content 500 is outputted to a display device. The content 500 comprises the recognized speech 502, which is based on audio of the content 500 that indicates “I AM HERE TO RESCUE YOU” The recognized speech 502 may, for example, be recognized using the speech recognition techniques described herein such as the transcription module 340 that is described with respect to FIG. 3. The transcription module 340 may then send data comprising the recognized speech to the translation module 345 which may determine that the recognized speech 502 is in the English language. The computing device outputting the content 500 may have been configured to translate the recognized speech from a language of the recognized speech to another language. For example, the determination of the target language into which to translate the recognized speech 502 may be based on user selection (e.g., a viewer of the content may interact with an interface and select an option to translate and automatically dub speech in content into a preferred language) or automatically by using a listening module 350 (e.g., a microphones of the display device) to recognize a language being spoken by viewers of the content in the vicinity of the display device. If the recognized speech 502 does not match the language being spoken by the viewers, the translation module 345 may translate the recognized speech into the language being spoken by the viewers.

The translated language generated by the translation module 345 may then be outputted in the form of the alternative audio 504. The alternative audio 504 may comprise a synthetic voice that is generated based on the use of voice and audio module 355 that may generate the alternative audio via an audio output device (e.g., the sound module 390). The alternative audio 504 may replace the audio that was originally generated in the content 500. In this example, the alternative audio 504 is a French language audio translation of the English “WELCOME TO MONTREAL” and indicates “BIENVENUE À MONTRÉAL” generated in the French language.

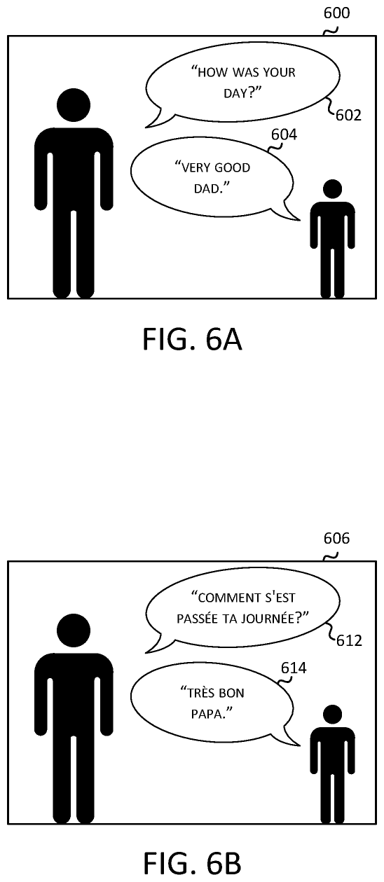

FIGS. 6A-B show examples of generating alternative voices. The computing devices shown in FIGS. 1-2 (e.g., the one or more mobile devices 125 and/or the edge device 300) and/or any other computing devices described herein may be used to implement the operations described herein.

In FIG. 6A, content 600 is outputted to a display device. The content 600 comprises the recognized speech of the original audio 602, which may be based on audio of the content 600 that indicates “I AM HERE TO RESCUE YOU.” The recognized speech of the original audio 602 may, for example, be recognized using the speech recognition techniques described herein such as the transcription module 340 that is described with respect to FIG. 3. The transcription module 340 may then send data comprising the recognized speech to the translation module 346 which may determine that the recognized speech of the original audio 602 is in the English language. The computing device outputting the content 600 may be configured to translate the recognized speech from a language of the recognized speech to another language. Further, the computing device may be configured to differentiate voices in the audio and generate alternative audio that comprises alternative voices that have voice characteristics of the recognized speech and speak a translated version (e.g., translated from the language used in the recognized speech into a preferred language selected by a user and/or based on recognition of user speech by a listening module as described with respect to FIG. 4A) of the recognized speech.

In this example, the edge device 300 may use the voice and audio module 355 to detect two voices and determine that one voice is an adult male voice with one set of voice characteristics and the other voice is a child's voice (e.g., a child of approximately ten years of age) with another set of voice characteristics. Further, the edge device 300 may use the translation module 345 to translate the language of the audio to an alternative language. The edge device may use the voice and audio module 355 to generate audio comprising one or more alternative voices (e.g., synthetic voices) with the voice characteristics of one or more original voices corresponding to the voices of the adult man and child. The translated language generated by the translation module 346 may then be outputted in the form of the alternative audio 612 and alternative audio 614. The alternative audio 612 and alternative audio 614 may comprise synthetic voices that are generated based on the use of voice and audio module 355 and may be generated via an audio output device (e.g., the sound module 390). The alternative audio 612 may replace the original audio 602 that was originally generated in the content 600. Further, the alternative audio 614 may replace the original audio 604 that was originally generated in the content 600.

In this example, the original audio 602 comprises an adult man using the English language to ask his child “HOW WAS YOUR DAY?” to which the child replies in the original audio 604 which indicates “VERY GOOD DAD” also using the English language. The voice characteristics of the original audio 602 may comprise the low pitch of an adult man's voice and may comprise other voice characteristics such as the intonation of words and the cadence of the voice. Further, the voice characteristics of the original audio 604 may comprise the high pitch of a boy's voice and may comprise other voice characteristics such as the intonation of words and the cadence of the voice which may be different from the voice characteristics of original audio 602.

The alternative audio 612 may comprise a French language audio translation of English language of original audio 602 and may indicate the adult man asking his child “COMMENT S′EST PASSÉE TA JOURNÉE?” generated in the French language and with voice characteristics that may match or be similar to the voice characteristics of the adult man in the original audio 602. Further, the alternative audio 614 may comprise a French language translation of the English language of the original audio 604 and may indicate the child replying “TRÈS BON PAPA” generated in the French language and with the voice characteristics that may match or be similar to the voice characteristics of the boy in the original audio 604.

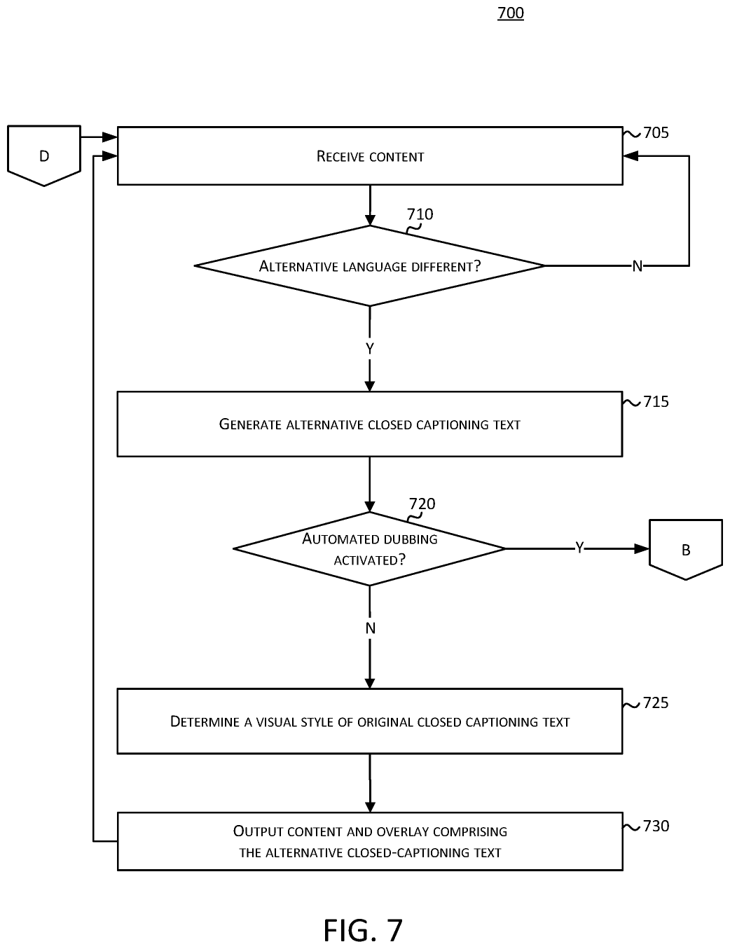

FIG. 7 is a flow chart showing an example method for generating alternative closed captioning text based on recognition of speech in content. The steps of the method 700 may be used to generate alternative closed captioning text in a language that is different from the language of recognized speech in received content. The steps of the example method 700 may be performed by any device described herein, including one or more mobile devices 125 and/or the edge device 300. Further, any part of the steps of the method 700 may be performed as part of the method 800 and/or the method 900. One, some, or all steps of the example method 700 may be omitted, performed in other orders, and/or otherwise modified, and/or one or more additional steps may be added. Further, the indications of “closed captioning text” in FIG. 7 (e.g., the “closed captioning text” indicated in steps 715, 725, and 730 of FIG. 7) are for the sake of example. In other examples, “audio” may be substituted for “closed captioning text” in step 715, step 725, and/or step 730 of FIG. 7).

In step 705, content may be received. The content may be received by an application (e.g., a software application) that is executing on a computing device (e.g., edge device 300). For example, the content may be received by a streaming video application that is configured to receive content that comprising video and/or audio which may be outputted to a display device of the computing device via the application. The content may comprise original audio. The original audio may comprise audio that may accompany video that is included in the content. For example, the original audio may comprise audio that comprises the speech (e.g., dialog) that is spoken in one or more original languages (e.g., dialog in the French language).

Further, the content may comprise original closed captioning text in one or more languages. For example, the original closed captioning text may comprise closed captioning text in the English language, the Russian language, and the French language. Further, the original closed captioning text may comprise one or more indications of one or more languages that may be received. For example, original closed captioning text that comprises closed captioning text in the Japanese language may comprise indications that closed captioning text in the English language, French language, and/or Russian language may be retrieved.

The content may comprise images (e.g., video), audio (e.g., original audio), and/or closed captioning text. For example, the content may comprise audio-video content (e.g., content of a streaming video) that comprises a combination of video and/or audio that is sent from a content computing device (e.g., content server 106) to one or more edge devices (e.g., one or more of the mobile devices 125). Further, the content may comprise original closed captioning text that is originally received with the content (e.g., original closed captioning text included as part of the content) or accompanying the content (e.g., original closed captioning text received separately from the content). The content may be received by a device that is used to view and/or listen to the content (e.g., edge device 300).

The content may comprise indications of times at which dialog in the original audio is spoken. For example, the content may comprise time stamps that indicate when dialog is being spoken as part of the original audio. The timing used to output original closed captioning text and/or alternative closed captioning audio may be based on the indications of times at which dialog in the original audio is spoken. For example, original closed captioning text may be outputted based on time stamps included in the indications of times at which dialog in the original audio is spoken. Further, the content may comprise an indication of one or more audio channels from which one or more original voices (e.g., voices from dialog of audio content) are outputted. For example, the content may comprise an indication that a first voice in a dialog between two voices is outputted by a left audio channel and that a second voice is outputted from a right audio channel.

In step 710, there may be a determination of whether an alternative language is different from the one or more original languages. For example, a computing device (e.g., edge device 300) may analyze the content and determine that the one or more original languages of the original closed captioning comprise the English language and the French language. Further, the computing device may determine that the alternative language is the Russian language, which is different from the one or more original languages of the English language and the French language. Based on the alternative language being different from the one or more original languages, step 715 may be performed.

Based on the alternative language not being different from the one or more original languages, step 705 may be performed. For example, a computing device (e.g., edge device 300) may analyze the content and determine that the one or more original languages of the original closed captioning comprise the Japanese language and the Korean language. Further, the computing device may determine that the alternative language is the Japanese language which is one of the one or more original languages.

The determination of whether an alternative language is different from the one or more original languages may be based on recognition of speech in the content (e.g., the original audio of the content and/or the original closed captioning text of the content). As described with respect to FIG. 3, a computing device (e.g., edge device 300) may analyze content (e.g., video content in audio-video mux 320) and use the translation module 345 to determine the language of the speech recognized in the content. Further, the determination that the alternative language is different from the one or more original languages of the original closed captioning text may be based on use of a machine learning model configured to recognize different spoken languages. As described with respect to FIG. 3. various machine learning models may be used to recognize the language being used in audio. For example, a computing device may determine that the English language is being used in the original audio of content that was received.

The determination of whether an alternative language is different from the one or more original languages may be based on a comparison of the alternative language to indications of the one or more original languages in the original closed captioning text. For example, the alternative language may be Russian and the original closed captioning text may comprise indications that the one or more original languages are Japanese and Korean. Based on comparing, a computing device (e.g., edge device 300) may determine that the alternative language is different from the one or more original languages.

In step 715, alternative closed captioning text may be generated and/or accessed. The alternative closed captioning text may comprise a translation of the original audio into an alternative language that is different from the one or more original languages. For example, if the one or more original languages comprise the Russian language and the English language, and the one or more original languages do not comprise the French language, the alternative language may be the French language. Generation of the alternative closed captioning text may be based on recognition of speech of the original audio (e.g., speech in original audio of content may be recognized). For example, as described with respect to FIG. 3, a computing device (e.g., edge device 300) may analyze content (e.g., audio-video mux 320) and use the transcription module 340 and/or translation module 345 to detect and/or recognize speech in the original audio of the content.

Recognition of speech in the original audio may be based on use of a machine learning model configured to recognize speech. As described with respect to FIG. 3, various machine learning models may be used to detect and/or recognize speech in audio. For example, transcription module 340 may analyze audio, detect audio patterns that correspond to speech, and generate a transcription of the speech detected in the audio. Further, generating the alternative closed captioning text may comprise the use of one or more machine learning models that are configured to receive input comprising the original closed captioning text and an indication of the alternative language and generate output comprising the alternative closed captioning text.

The alternative closed captioning text may be accessed instead of generating the alternative closed captioning text or in addition to generating the alternative closed captioning text. For example, edge device 300 may be configured to access alternative closed captioning text if the alternative closed captioning text is available. If the alternative closed captioning text is not available, the edge device may generate the alternative closed captioning text. There may be a determination of whether alternative closed captioning text is available. For example, a computing device (e.g., edge device 300) alternative content may search (e.g., search edge device 300 and/or a remote computing device such as content server 106) for alternative closed captioning text that corresponds to the content that is received (e.g., content comprising audio-video content of a streaming television show). If alternative closed captioning text is available (e.g., stored locally on edge device 300 and/or accessible via a remote computing device such as content server 106), the alternative closed captioning text may be accessed and/or retrieved. The alternative closed captioning text that is accessed may comprise or be based on alternative closed captioning text that was previously generated by another device (e.g., another edge device) and stored for later use.

Further, transcription module 340 may be configured to distinguish different types of audio patterns in audio content. For example, transcription module 340 may be configured to distinguish the sound of speech (e.g., one or more voices speaking) from the sound of a violin, a piano, the wind blowing, an automobile engine, a barking dog, a meowing cat, and/or a ringing bell. Speech may not be recognized if content does not include audio, speech in the content is inaudible (e.g., improperly recorded speech that is too low in volume to detect), speech is interfered with by other recorded audio (e.g., content in which the sound of heavy machinery prevents speech from being recognized and/or intelligible), and/or no speech is present in a portion of content that is analyzed.

As described with respect to FIG. 3, a device (e.g., edge device 300) may use a translation module to translate the original closed captioning text from the language of the original closed captioning text to an alternative language. The alternative closed captioning text may comprise text in an alternative language that is different from the language of the original closed captioning text. For example, the edge device 300 may translate original closed captioning text in the English language into alternative closed captioning text in the Russian language. Generating the alternative closed captioning text may comprise determining, based on recognition of a language of speech detected in proximity to the display device that outputs the content, that the alternative language of the alternative closed captioning text matches the language of the speech detected in proximity to the display device. For example, a microphone may be used to detect speech that is spoken in proximity to the display device. Further, as described with respect to FIG. 3, a listening module 350 may be used to determine an alternative language based on recognizing a language spoken in proximity to the display device.

The alternative closed captioning text that is generated may be based on the language that was recognized in proximity to the display device. Recognition of a language in the speech spoken in proximity to the display device may occur prior to the content being outputted. For example, recognition of the language in the speech spoken in proximity to the display device may occur on an ongoing basis, and any speech recognized within an hour or a day of the content being received and/or outputted may be used as the language into which the content is translated (e.g., if French is recognized thirty minutes before content is received then original audio of content may be translated into the French language).

Further, recognition of the speech (e.g., recognition of speech and the language in the speech) in proximity to the display device may be performed on an ongoing basis and data indicating the language of the speech (e.g., data indicating that a recognized language is the Russian language or the English language) may be generated. The data indicating the language of the speech may comprise an indication of the language in the recognized speech and may be generated without generating a transcription of any part of the recognized speech.

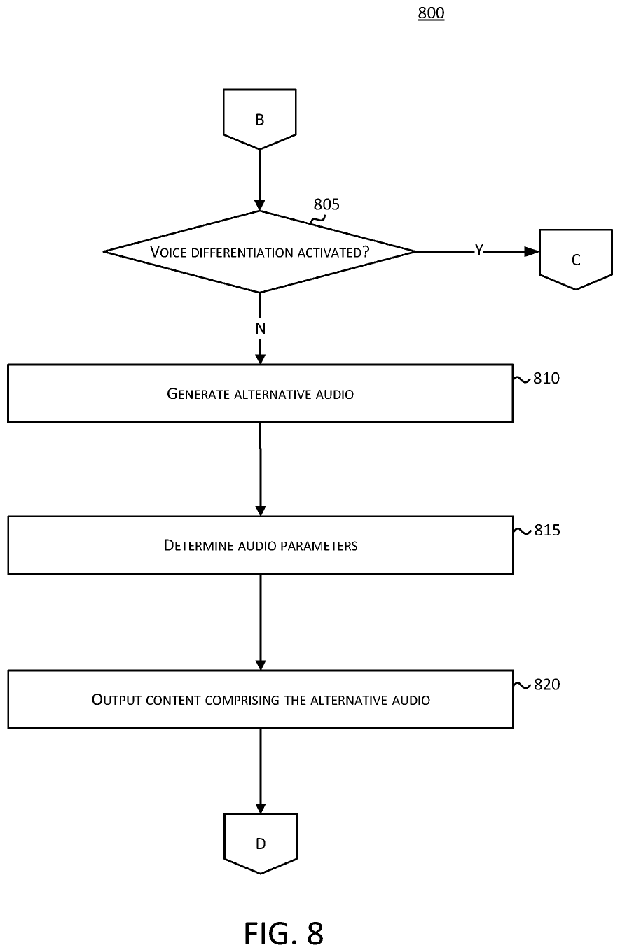

In step 720, there may be a determination of whether automated dubbing (e.g., language replacement) is activated (e.g., a viewer of the content has selected an option to turn on automated voice dubbing via a user interface of the edge device 300) in the content. For example, a computing device (e.g., edge device 300) may analyze the playback settings of content being outputted and determine whether automated dubbing is activated. Based on automated dubbing being activated, step 805 may be performed by way of the “B” connector indicated in FIGS. 7 and 8. Based on automated dubbing not being activated. step 725 may be performed. For example, a computing device (e.g., edge device 300) may analyze the playback settings of content being outputted and determine that automated dubbing is not activated (e.g., an option to turn on automated voice dubbing is not selected).

In step 725, a visual style of the original closed captioning text may be determined. A visual style of the original closed captioning text may be determined based on analysis of the original closed captioning text which may comprise indications of visual style comprising a font, font size, line spacing, background color, and/or text color of the original closed captioning text.

Further, the visual style of the original closed captioning text may be determined based on use of one or more machine learning models that are configured to determine the visual style of the original closed captioning text based on processing the original closed captioning text that is received and/or the previously outputted original closed captioning text (e.g., the original closed captioning text that is displayed on a display device). The one or more machine learning models may be configured to determine a spatial arrangement of the original closed captioning text within the content. Further the one or more machine learning models may be configured to determine a font, font size, line spacing, background color, and/or text color of the original closed captioning text.

Determining the visual style of the original closed captioning text may comprise determining an onscreen location for the overlay based on an onscreen location of the original closed captioning text. For example, edge device 300 may determine a set of coordinates corresponding to the location of the original closed captioning text and generate the overlay comprising the alternative closed captioning text at the same set of coordinates.

Determining the visual style of the original closed captioning text may comprise determining a color of the alternative closed captioning text based on a color of the original closed captioning text. For example, edge device 300 may determine one or more colors in which the original closed captioning text is outputted and generate an overlay in which the alternative closed captioning text is outputted using the same colors as the original closed captioning text.

Determining the visual style of the original closed captioning text may comprise determining a font of the alternative closed captioning text based on a font of the original closed captioning text. For example, edge device 300 may determine a font in which the original closed captioning text is outputted and generate an overlay in which the alternative closed captioning text is outputted using the same font as the original closed captioning text. Further, emphasis in the original closed captioning text may be used in the alternative closed captioning text. For example, underlining, italics, and/or bold type faces used in the original closed captioning text may be used in the alternative closed captioning text.

Determining the visual style of the original closed captioning text may comprise determining an amount of the alternative closed captioning text to display on the overlay during a time interval based on an amount of the original closed captioning text that is outputted during the time interval. For example, edge device 300 may determine an amount (e.g., a percentage of outputted content) of the video content that is covered by the original closed captioning text and generate an overlay in which the overlay occupies a similar or the same portion of the video content as the original closed captioning text.

Determining the visual style of the original closed captioning text may comprise determining a rate of outputting the overlay based on a rate at which the original audio is outputted. For example, edge device 300 may determine a number of words per second at which the original closed captioning text is outputted and generate an overlay in which the alternative closed captioning text is outputted at the same number of words per second as the original closed captioning text.

In step 730, the content and an overlay may be outputted via an output device (e.g., a display device). The overlay may comprise the alternative closed captioning text in the visual style of the original closed captioning text. For example, the visual style of the original closed captioning text may be determined to use an Arial font that is white and single spaced that is left justified. Further, the overlay may be determined to occupy a region at the bottom edge of content (e.g., the bottom ten percent of a rectangular viewing area within which content is displayed). The overlay may comprise the alternative closed captioning text. For example, the display module 395 may output content comprising an English language comedy show and an overlay comprising alternative closed captioning text with a French language translation of the English language original closed captioning text (e.g., English language closed captioning text that was received with the content or as part of the content and which may be outputted with the content).

The overlay may cover or mask the closed-captioning text. For example, the overlay may comprise a black background that covers the region in which closed captioning text would be generated. Further, the overlay may be outputted next to the original closed captioning text. For example, the overlay may be outputted on top of the original closed captioning text, below the original closed captioning text, to the left of the original closed captioning text, or to the right of the original closed captioning text. Further, the alternative closed captioning text may be outputted at the times at which the language in the original audio is spoken. For example, the alternative closed captioning text may be outputted based on the indications of the times at which dialog in the original audio is spoken as described in step 705. After the content and the overlay are outputted, step 705 may be performed.

FIG. 8 is a flow chart showing an example method for generating alternative audio based on recognition of speech in content. The steps of the method 800 may be used to generate alternative audio in a language that is different from the language of recognized speech in received content. The steps of the example method 800 may be performed by any device described herein, including one or more mobile devices 125 and/or the edge device 300. Further, any part of the steps of the method 800 may be performed as part of the method 700 and/or the method 900. One, some, or all steps of the example method 800 may be omitted, performed in other orders, and/or otherwise modified, and/or one or more additional steps may be added. Further, the indications of “audio” in FIG. 8 (e.g., the “audio” indicated in steps 810, 815, and 820 of FIG. 8) are for the sake of example. In other examples, “closed captioning text” may be indicated in FIG. 8 (e.g., “closed captioning text” may be substituted for “audio” in steps 810, 815, and 820 of FIG. 8). The steps of FIG. 8 steps may begin with the generation of alternative audio following a determination that automated dubbing is activated in step 720 of the method 700.

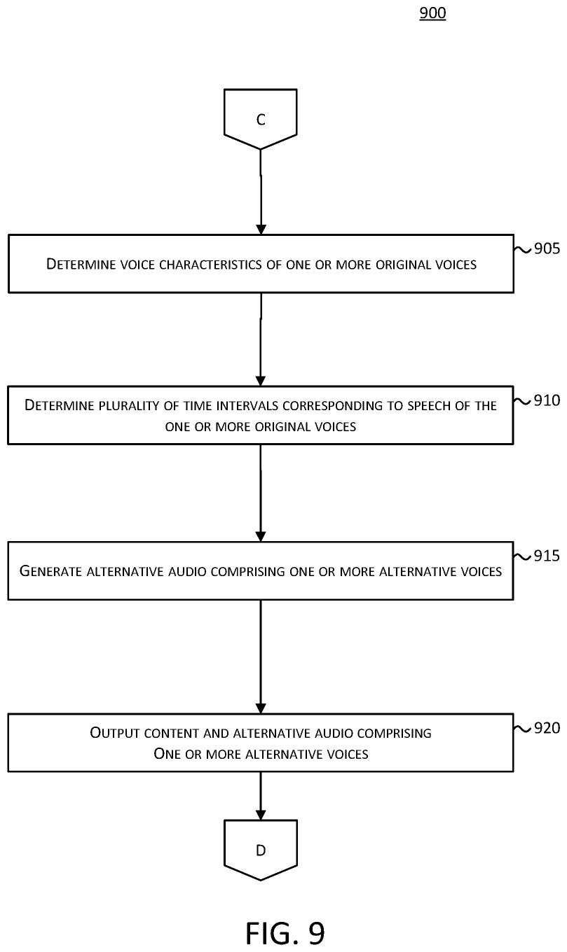

In step 805, there may be a determination of whether automated voice differentiation (e.g., distinguishing different voices in original audio and analyzing voice characteristics of the voices) is activated (e.g., a viewer of the content has selected an option to turn on automated voice differentiation via a user interface of the edge device 300) in the content. For example, a computing device (e.g., edge device 300) may analyze the playback settings of content being outputted and determine whether automated voice differentiation is activated. Based on automated voice differentiation being activated, step 905 may be performed by way of the “C” connector indicated in FIGS. 8 and 9. Based on automated voice differentiation not being activated, step 810 may be performed. For example, a computing device (e.g., edge device 300) may analyze the playback settings of content being outputted and determine that automated voice differentiation is not activated (e.g., an option to turn on automated voice differentiation is not selected).

In step 810, Alternative audio may be generated and/or accessed. The alternative audio may comprise a translation of an original language of the original audio into an alternative language which may be a different language from the language of the original audio. A device (e.g., edge device 300) may use the translation module 345 to translate the language of the original audio to an alternative language. For example, the edge device 300 may translate original audio in the Russian language into alternative audio in the French language. Further, generating the alternative audio may comprise the use of one or more machine learning models. The one or more machine learning models may be are configured to receive input comprising the original audio and an indication of the alternative language and generate output comprising the alternative audio.

Generating the alternative audio may comprise determining, based on recognition of speech detected in proximity to the display device that outputs the content comprising original audio, that the alternative language of the alternative audio matches the language of the speech detected in proximity to the display device. For example, as described with respect to FIG. 3, a listening module 350 may be used to determine the alternative language based on recognizing a language spoken in the vicinity of the display device (e.g., within a predetermined distance of the display device). The alternative audio that is generated (e.g., by voice and audio module 355) may be based on the alternative language of the speech that was detected in proximity to the display device.

The alternative audio may be accessed instead of generating the alternative audio or in addition to generating the alternative audio. For example, edge device 300 may be configured to access alternative audio if the alternative audio is available. If the alternative audio is not available, edge device may generate the alternative audio. There may be a determination of whether alternative audio is available. For example, a computing device (e.g., edge device 300) alternative content may search (e.g., search edge device 300 and/or a remote computing device such as content server 106) for alternative audio that corresponds to the content that is received (e.g., content comprising audio-video content of a streaming television show). If alternative audio is available (e.g., stored locally on edge device 300 and/or accessible via a remote computing device such as content server 106), the alternative audio may be accessed and/or retrieved. The alternative audio that is accessed may comprise or be based on alternative audio that was previously generated by another device (e.g., another edge device) and stored for later use. In step 815, audio parameters of the original audio may be determined. For example, a computing device (e.g., edge device 300) may process the original audio and determine audio parameters comprising a bit rate of the original audio, an audio mix of the original audio (e.g., a stereo sound audio mix or a five channel surround sound audio mix), and/or a volume of the original audio (e.g., a current volume of the original audio in decibels). Determination of audio parameters of the original audio may be based on processing of the original audio and/or metadata of the content (e.g., metadata of the original audio). For example, metadata of the original audio may indicate that the bitrate of the original audio is 192 kilobytes per second (kbps) and that the original audio is a two channel stereo sound audio mix that may be outputted at a volume of sixty decibels.

In step 820, the content and the alternative audio may be outputted. The alternative audio may be outputted via a display device that is used to output the content. Further, the content and the alternative audio may be outputted based on the audio parameters of the original audio. For example, the sound module 390 may output content comprising alternative audio that replaces the Korean language audio in the original audio with alternative audio comprising a French language translation of the original Korean language audio. Further, the audio parameters of the Korean language audio in the original audio may indicate a 128 kbps bitrate and a stereo sound mix. The alternative audio in the French language may be outputted at a 128 kbps bitrate and have a stereo sound audio mix that match the bitrate and audio mix of the original audio. A computing device (e.g., edge device 300) may stop or mute the original audio when the alternative audio is outputted.

The alternative audio may be outputted at a higher volume (e.g., a higher sound pressure level) than the volume of the original audio. For example, the alternative audio may be outputted at a sound pressure level of fifty decibels and the original audio may be outputted at a sound pressure level of twenty-five decibels. Further, the original audio may either not be outputted or have a sound pressure level of zero and thereby be inaudible. Additionally, the alternative audio may replace the original audio. For example, French language alternative audio may replace English language audio. Further, the alternative audio may be outputted at the times at which the recognized speech in the original audio is outputted. For example, the alternative audio may be outputted at times that are similar to the times at which the corresponding recognized speech would be outputted. After the content comprising the alternative audio is outputted, step 705 may be performed by way of the “D” connector indicated in FIG. 8.

FIG. 9 is a flow chart showing an example method for generating alternative audio comprising different voices based on recognition of speech in content. The steps of the method 900 may be used to generate alternative audio comprising different voices in a language that is different from the language of recognized speech in received content. The steps of the example method 900 may be performed by any device described herein, including one or more mobile devices 125 and/or the edge device 300. Further, any part of the steps of the method 800 may be performed as part of the method 700 and/or the method 800. One, some, or all steps of the example method 900 may be omitted, performed in other orders, and/or otherwise modified, and/or one or more additional steps may be added. The indications of “one or more original voices” in FIG. 9 (e.g., the “one or more original voices” indicated in steps 905 and 910 of FIG. 9) are for the sake of example. In other examples, “audio” may be indicated in FIG. 9 (e.g., “audio” may be substituted for “one or more original voices” in steps 905 and 910 of FIG. 9). Further, the indications of “audio comprising one or more alternative voices” in FIG. 9 (e.g., the “audio comprising one or more alternative voices” indicated in steps 915 and 920 of FIG. 9) are for the sake of example. In other examples, “closed captioning text” or “audio” may be indicated in FIG. 9 (e.g., “closed captioning text” or “audio” may be substituted for “audio comprising one or more alternative voices” in steps 915 and 920 of FIG. 9). The steps of FIG. 9 steps may begin with the determination of voice characteristics of original voices following the determination that automated voice differentiation is activated in step 805 of the method 800.

In step 905, voice characteristics of one or more original voices in content comprising original audio may be determined. Determination of the voice characteristics of the one or more original voices may be based on recognition of speech in the original audio. For example, a computing device (e.g., edge device 300) may analyze content (e.g., audio-video mux 320) and use voice and audio module 355 to recognize different voices in audio content and/or determine voice characteristics of the different voices that were recognized. The computing device may for example, determine that two voices, a man's voice and a woman's voice, were recognized. Further, the computing device may determine various voice characteristics of the voices including pitch characteristics, articulation characteristics, inflection characteristics, enunciation characteristics, cadence characteristics, resonance characteristics, timbre characteristics, gender characteristics, age characteristics, and/or accent characteristics of each of the recognized voices. A combination of the voice characteristics may be used to distinguish original voices from one another. Further, the voice characteristics may be used in the generation of alternative audio that comprises an alternative voice with the voice characteristics of the original voice and which translates speech of the original voice into a different language.

In step 910, a plurality of time intervals corresponding to the speech of the one or more original voices of the original audio may be determined. For example, if the one or more original voices comprise two voices (e.g., a man's voice and a woman's voice), the original audio may comprise time intervals in which a first voice is detected, time intervals in which a second voice is detected, and time intervals in which both the first voice and the second voice are detected. For each time interval of the plurality of time intervals of the original audio, a computing device (e.g., edge device 300) may determine which of the voices is detected. The time intervals during which one or more voices are detected may be used to determine the time intervals at which alternative voices may be generated and/or substitute the original voices.

Further, determining the plurality of time intervals corresponding to the speech of the one or more original voices may comprise determining one or more voice identities of the one or more original voices. Each of the one or more voice identities may correspond to a different original voice in the original audio of the content. For example, content comprising original audio in which three people including an adult man, adult woman, and five year old girl are speaking may be analyzed and the voice identities (e.g., man, woman, and girl) may be determined based on similarities in voice characteristics of the original audio during different time intervals of the content. The one or more voice identities may be determined based on use of a machine learning model that is configured to analyze the voice characteristics of the one or more original voices and determine the time intervals corresponding of the original audio that have speech with similar voice characteristics (e.g., portions of the original audio with pitch, timbre, cadence, and/or resonance that indicate the original audio corresponds to the same voice). For example, the edge device 300 may use a voice and audio module 355 to analyze original audio comprising one minute of dialogue between an adult woman and a ten year old boy. The voice and audio module 355 may determine the time intervals of the original audio during which speech of the adult woman's voice is detected and the time intervals during which speech of the ten year old boy's voice is detected.

In step 915, alternative audio comprising one or more alternative voices based on the voice characteristics of the one or more original voices may be generated and/or accessed. The one or more alternative voices of the alternative audio may comprise a translation of the one or more original voices into an alternative language that is different from an original language of the one or more original voices. For example, alternative audio comprising alternative Russian speaking voices with the voice characteristics of older men may be generated to replace original audio comprising original English speaking voices with the voice characteristics of older men.

The alternative audio comprising one or more alternative voices based on the voice characteristics of the one or more original voices may be accessed instead of generating the alternative audio or in addition to generating the alternative audio. For example, edge device 300 may be configured to access alternative audio if the alternative audio is available. If the alternative audio comprising one or more alternative voices is not available, edge device may generate the alternative audio. There may be a determination of whether alternative audio comprising one or more alternative voices is available. For example, a computing device (e.g., edge device 300) alternative content may search (e.g., search edge device 300 and/or a remote computing device such as content server 106) for alternative audio that corresponds to the content that is received (e.g., content comprising audio-video content of a streaming television show). If alternative audio comprising one or more alternative voices is available (e.g., stored locally on edge device 300 and/or accessible via a remote computing device such as content server 106), the alternative audio may be accessed and/or retrieved. The alternative audio comprising one or more alternative voices that is accessed may comprise or be based on alternative audio comprising one or more alternative voices that was previously generated by another device (e.g., another edge device) and stored for later use.

The alternative audio comprising the one or more alternative voices may be generated for each of the plurality of time intervals. For example, a computing device (e.g., edge device 300) may determine that a thirty second time interval of the original audio may comprise a first original voice speaking for the first ten seconds, a second original voice speaking for the subsequent twelve seconds, and both the first voice and the second voice speaking for the final eight seconds. For the same thirty second time interval of content, the computing device may generate a first alternative voice with the voice characteristics of the first original voice that speaks for the first ten seconds, a second alternative voice with the voice characteristics of the second original voice that speaks for the subsequent twelve seconds, and the first alternative voice and the second alternative voice speaking together for the final eight seconds.

The one or more alternative voices may be generated based on one or more voice samples corresponding to the voice characteristics of the one or more original voices that were selected. The one or more alternative voices may be based on the voice characteristics of the one or more original voices. For example, a computing device (e.g., edge device 300) may use the translation module 345 to translate the language of the original audio to an alternative language. The one or more alternative voices may be generated based on use of a machine learning model configured to translate the language used by the one or more original voices into the alternative language. For example, the edge device 300 may use a voice and audio module 355 to generate one or more alternative voices (e.g., synthetic voices) with the voice characteristics of one or more original voices. Further, the one or more machine learning models may be configured to generate the one or more alternative voices based on input comprising the one or more original voices and the voice characteristics of the one or more original voices.

Further, generating the alternative audio comprising the one or more alternative voices may comprise selecting one or more voice samples corresponding to the voice characteristics of the one or more original voices. The one or more voice samples may be selected based on use of a machine learning model configured to analyze the voice characteristics of the one or more original voices and select one or more voice samples that have sampled voice characteristics that are similar to (e.g., sampled voice characteristics that match the voice characteristics of the one or more original voices and/or match a predetermined proportion of the voice characteristics of the one or more original voices). For example, the edge device 300 may use a voice and audio module 355 to analyze one or more voice samples that have similar voice characteristics (e.g., pitch, inflection, and/or tone) to the voice characteristics of the one or more original voices.

The alternative audio comprising the one or more alternative voices may comprise speech with voices using an alternative language that is different from the language of the speech in the original audio. For example, the edge device 300 may translate original audio of an adult man that speaks the Russian language in a low voice and quick cadence into alternative audio of an adult man that speaks the French language in a low voice a quick cadence and other voice characteristics that are similar to the original audio in the Russian language.

In step 920, the content may be outputted without the original audio and comprising the alternative audio comprising the one or more alternative voices. For example, the sound module 390 may output content comprising video for a Thai language children's show with alternative audio that replaces the Thai language audio in the content with alternative audio comprising children's voices similar to those of children in the Thai language audio speaking a translated version of the Thai language audio in the French language. The one or more alternative voices of the alternative audio may be outputted via the audio channels from which the one or more original voices of the original audio are outputted. For example, if a first voice of the content was originally outputted from a left audio channel, the alternative voice corresponding to the first voice would also be outputted from the left audio channel. After the content comprising the alternative audio comprising the one or more alternative voices is outputted, step 705 may be performed by way of the “D” connector indicated in FIG. 9.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A method comprising:
receiving, by an application executing on a computing device, content comprising original audio and original closed captioning text in one or more original languages;
generating, based on recognition of speech of the original audio, alternative closed captioning text comprising a translation of the original audio into an alternative language that is different from the one or more original languages;
determining a visual style of the original closed captioning text; and
outputting, via a display device, the content and an overlay comprising the alternative closed captioning text in the visual style of the original closed captioning text.

2. The method of claim 1, wherein the computing device comprises an edge device.

3. The method of claim 1, wherein the generating, based on recognition of speech of the original audio, alternative closed captioning text comprising a translation of the original audio into the alternative language comprises:
determining, based on recognition of a language of speech detected in proximity to the display device, that the alternative language of the alternative closed captioning text matches the language of the speech detected in proximity to the display device.

4. The method of claim 1, wherein the determining the visual style of the original closed captioning text comprises:
determining an onscreen location for the overlay based on an onscreen location of the original closed captioning text.

5. The method of claim 1, wherein the determining the visual style of the original closed captioning text comprises:
determining a color of the alternative closed captioning text based on a color of the original closed captioning text.

6. The method of claim 1, wherein the determining the visual style of the original closed captioning text comprises:
determining a font of the alternative closed captioning text based on a font of the original closed captioning text.

7. The method of claim 1, wherein the determining the visual style of the original closed captioning text comprises:
determining an amount of the alternative closed captioning text to display on the overlay based on an amount of the original closed captioning text that is outputted.

8. The method of claim 1, wherein the outputting, via a display device, the content and an overlay comprising the alternative closed captioning text in the visual style of the original closed captioning text comprises:
determining a rate of outputting the alternative closed captioning text on the overlay based on a rate at which the original audio is outputted.

9. The method of claim 1, wherein the recognition of the speech in the original audio is based on use of a machine learning model configured to recognize speech.

10. The method of claim 1, wherein the content comprises indications of times at which dialog in the original audio is spoken, and wherein the alternative closed captioning text is outputted at one or more times at which the dialog in the original audio is spoken.

11. The method of claim 1, wherein the overlay covers the original closed captioning text.

12. The method of claim 1, wherein the overlay is outputted next to the original closed captioning text.

13. A method comprising:
generating, based on recognition of speech of content comprising original audio, alternative audio comprising a translation of an original language of the original audio into an alternative language that is different from the original language;
determining audio parameters of the original audio; and
outputting, via a display device, based on the audio parameters of the original audio, the content and the alternative audio.

14. The method of claim 13, wherein the audio parameters comprise a bit rate of the original audio or an audio mix of the original audio.

15. The method of claim 13, wherein the generating, based on the recognition of speech of the original audio, alternative audio based on the original audio and the alternative language comprises:
determining, based on recognition of a language of speech detected in proximity to the display device, that the alternative language of the alternative audio matches the language of the speech detected in proximity to the display device.

16. The method of claim 13, wherein the alternative audio is generated based on use of a machine learning model configured to translate the original language into the alternative language.

17. A method comprising:
determining, by a computing device, based on recognition of speech in content comprising original audio, voice characteristics of one or more original voices of the original audio;
determining a plurality of time intervals corresponding to the speech of the one or more original voices of the original audio;
generating, for each of the plurality of time intervals, based on the original audio and the voice characteristics of the one or more original voices, alternative audio comprising one or more alternative voices with the voice characteristics of the one or more original voices and translated into an alternative language that is different from a language used by the one or more original voices; and
outputting, via a display device, the content and the alternative audio comprising the one or more alternative voices translated into the alternative language.

18. The method of claim 17, wherein the voice characteristics comprise a gender characteristic, an age characteristic, or an accent characteristic.

19. The method of claim 17, wherein the content comprises an indication of audio channels from which the one or more original voices are outputted, and wherein the one or more alternative voices of the alternative audio are outputted via the audio channels from which the one or more original voices are outputted.

20. The method of claim 17, wherein the one or more alternative voices are generated based on use of a machine learning model configured to generate the alternative audio comprising the one or more alternative voices using the alternative language.
